(19) United States
(12) Patent Application Publication
(10) Pub. No.: US 2021/0067910 A1
(43) Pub. Date: Mar. 4, 2021

(54) METHOD OF DETECTING MULTIPLE DEVICES ASSOCIATED WITH A VEHICLE

(71) Applicant: Passport Labs, Inc., Charlotte, NC (US)

(72) Inventors: Michael N.B. Scully, Charlotte, NC (US); Raymond Robinson, III, Charlotte, NC (US)

(21) Appl. No.: 17/003,210

(22) Filed: Aug. 26, 2020

Related U.S. Application Data
(60) Provisional application No. 62/893,487, filed on Aug. 29, 2019.

(51) Int. Cl. H04W 4/02; H04W 4/029; G07C 5/00; H04W 4/80

(52) U.S. Cl. CPC H04W 4/027; H04W 4/80; G07C 5/008; H04W 4/029

(57) ABSTRACT

A method of detecting multiple devices associated with a vehicle includes: positioning two or more mobile computing devices in a common vehicle; collecting at least one proximity factor about each of the mobile computing devices, wherein the at least one proximity factor evidences close physical proximity of the two or more mobile computing devices; using an electronic processor, executing at least one software rule to make a proximity inference of the mobile computing devices, based on the at least one proximity factor; and storing the result of the proximity inference for further use.

### BACKGROUND OF THE INVENTION

This invention relates generally to location methods, and more particularly to a method for inferring that two or more electronic devices are located in or associated with a common vehicle.

It is known to use a software application running on a mobile computing device to track a user's location and ultimately to report that location to a remote computer system. More specifically, the software application may be used to report that the mobile computing device has passed or is currently located in a significant geographic location (e.g. a toll plaza). The remote computer system may use the location information to associate the electronic devices with services. For example, it may calculate and process payment of fees, such as road tolls or parking fees. Such services or fees are commonly charged on a per-vehicle basis. It may also make an applicable inference available to an external party or system.

One problem with prior art systems is that multiple users of the system, or multiple devices per single user, may be simultaneously located in a common vehicle, leading to the possibility that multiple mobile devices may interact with the remote computer system in an attempt to access a service at the same time. This can lead to charging an incorrect user, double-charging for single service, and/or applying other applicable business logic incorrectly.

### BRIEF SUMMARY OF THE INVENTION

This problem is addressed by an automated method detecting the presence of multiple mobile devices associated with (usually, but not necessarily, according to proximity) a single vehicle.

According to one aspect of the technology described herein, a method of detecting multiple devices associated with a vehicle includes: positioning two or more mobile computing devices in a common vehicle; collecting at least one proximity factor about each of the mobile computing devices, wherein the at least one proximity factor evidences close physical proximity of the two or more mobile computing devices, using an electronic processor, executing at least one software rule to make a proximity inference of the mobile computing devices, based on the at least one proximity factor; and storing the result of the proximity inference for further use.

### BRIEF DESCRIPTION OF THE DRAWINGS

The invention may be best understood by reference to the following description taken in conjunction with the accompanying drawing figures, in which:

FIG. 1 is a schematic diagram of an exemplary system for determining mobile computing device proximity; and

FIG. 2 is a schematic diagram of a vehicle traveling along a road route system.

### DETAILED DESCRIPTION OF THE INVENTION

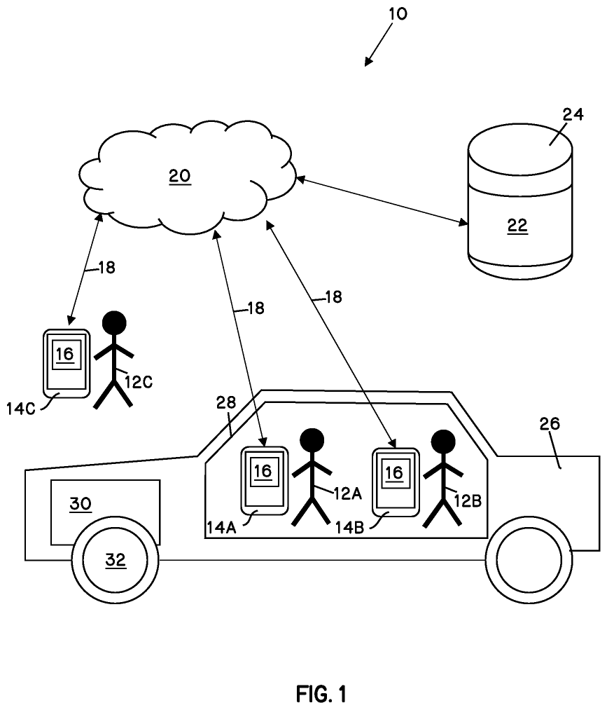

Referring to the drawings wherein identical reference numerals denote the same elements throughout the various views, FIG. 1 illustrates an exemplary mobile system 10 for use by multiple users, referenced generally by number 12.

The method of the present invention is implemented using a conventional mobile computing device, referenced generally by number 14, for each user. The mobile computing device 14 includes one or more microprocessors operable to execute programmed instructions and supporting components such as an electrical power source (e.g. battery), input/output devices (e.g. keyboard, touchscreen display, microphone, and/or speakers), and one or more transceivers operable to communicate data over various wireless protocols including but not limited to BLUETOOTH, Wi-Fi, and/or cellular networks. The mobile computing device 14 may include one or more physical data ports for two-way data transmission, for example a port compatible with a universal serial bus (USB) cable. Nonlimiting examples of commercially-available mobile computing devices include laptop computers, tablet computers, vehicle “infotainment” system (i.e. head unit), “smart watches”, and “smartphones”.

One or more of the mobile computing devices 14 may implement at least one location service, defined as a combination of hardware and software operable to determine the geographic location of the mobile computing device 14. Nonlimiting examples of location services include inertial navigation systems, satellite-based navigation (e.g. GPS, GLONASS), Wi-Fi-based location, and cellular-based location.

In the illustrated example, the mobile computing device 14 is a conventional smartphone. The mobile computing device 14 is provisioned with a client software program (also referred to as a “client application” or “client app” 16) containing appropriate programming for carrying out the method described herein on its own or in conjunction with a backend application 22.

At least one of the mobile computing devices 14 is connected by a communications channel 18 such as a Wi-Fi or a cellular data connection to a wide area network 20 such as the Internet. The connection may be direct or by proxy. The connection may be concurrent with the time period of interest or subsequent to that.

The system 10 may include a backend application 22 which communicates with the client app 16 through the wide area network 20. It will be understood that the backend application 22 may be hosted on one or more servers or individual user devices, which are connected to the wide area network 20. A single server 24 hosting the backend application 22 is depicted schematically in block diagram format. It will be understood that multiple servers or groups of servers could be used.

The steps of the method described herein may be carried out on one or more processors. It will be understood that the method may be carried out entirely using processors contained within the mobile computing device 14, or entirely using processors contained external to the mobile computing device (e.g. in the server 24 or on another mobile or fixed computing device that can connect to the backend application 22 or client app 16), or by some combination of the two.

The mobile computing devices 14 are used in conjunction with a vehicle 26, shown schematically in FIG. 1.

The illustrated vehicle 26 includes a passenger compartment 28 and a drivetrain of a known type, such as the illustrated prime mover 30 which is coupled to wheels 32 through a transmission (not shown). The principles described herein are applicable to all types of vehicles, including mass transit vehicles such as buses or trains, and including those without passenger compartments, such as cargo vehicles, unmanned vehicles, drones, autonomous or semi-autonomous vehicles, electronic scooters, bicycles, etc.

In operation, the passenger compartment 28 may be occupied by the user 12 along with his or her mobile computing device 14. In one exemplary usage, the passenger compartment 28 may be occupied by two or more users labeled 12A, 12B along with their respective mobile computing devices 14A, 14B. While two users are used for purposes of description, it will be understood that the method described herein is suitable for any number of users. In another exemplary usage, a single user 12A may have a mobile computing device 14A that contains multiple relevant applications 16 each of which can be treated as a separate mobile computing device for the purposes of this method (e.g., a dedicated tolling app and a tolling function within a navigation app,). In another exemplary usage, a single user 12A may have a mobile computing device 14A and the vehicle 26 may include an electronic device (e.g. infotainment system) serving the role of a second mobile computing device.

One example of an end use for the method described herein is usage within a method or system which depends on accurate determination that a mobile computing device 14 is located at, or has passed through, a significant geographic location within a specific time window, which can be compared to similar data from another mobile computing device 14 within the same specified time window. Non-limiting examples of such systems include automated parking systems and automated road tolling systems.

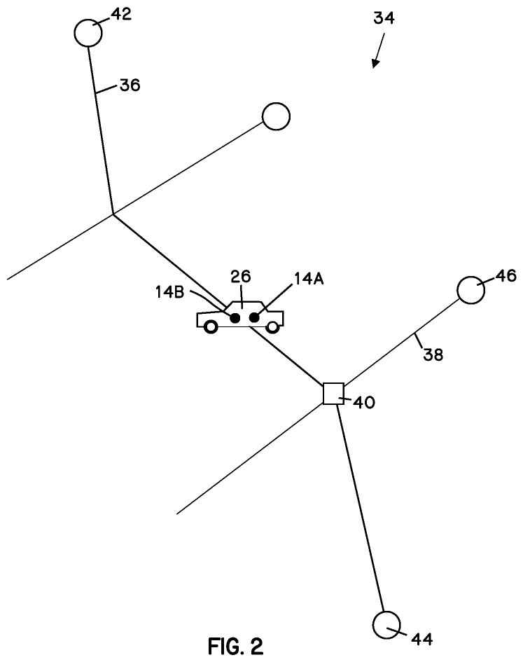

FIG. 2 is a diagram of road route structure 34 comprising a primary road 36 and a secondary road 38 which intersects the primary road 36. A checkpoint in the form of a toll plaza 40 is positioned on the primary road 36.

As an example, the vehicle 26 may travel along the primary road 36 from a starting point 42, passing through toll plaza 40 on its way to an end point 44, 46. While a vehicle travelling on a road is used as an example, it will be understood that the principles described herein are equally applicable to vehicles travelling off-road, vehicles traveling on rails, vehicles traveling by sidewalk or pedestrian way, vehicles traveling by air, stationary vehicles, or land or sea vehicles.

One or more of the location services described above may be used to determine the location of the mobile computing device 14 and to report that location to a remote computing device. For example, when the location service determines the mobile computing device 14 is at the toll plaza 40 at a specific time, this time and location information may be reported to the server 24. This information may then be used to charge a toll to user 12.

However, as noted above, two or more users 12 may occupy the same vehicle 26 simultaneously. In order to implement system rules 10 (e.g. relating to access, billing, etc.) properly, it is necessary to determine when this situation occurs.

Accordingly, the backend application 22 and/or the client app 16 may be programmed with one or more rules or algorithms that function to make an inference that two or more of the mobile computing devices 14 are in a common vehicle 26 at a specific time. This may be referred to as a “proximity inference”.

In making the proximity inference, the system 10 collects and refers to pieces of information or facts referred to herein as “proximity factors”, each of which indicates or evidences close physical proximity to some degree. The proximity inference may be based on one or multiple proximity factors. Generally speaking, the greater the number of proximity factors, the number of data types provided by a proximity factor, and the greater the time period for recording data from proximity factors, the greater the confidence in the proximity determination.

It is assumed that the location of mobile computing devices 14 is capable of being determined when required as necessary for operation of the system 10.

Accordingly, a determination of the absolute location of the mobile computing devices 14 is not critical to the method described herein.

The system 10 may incorporate machine learning strategies and/or statistical methods and/or empirical methods to improve the location inference using multiple proximity factors. For example, the system 10 may identify a combination of multiple proximity factors, none of which individually determine with total certainty that two or more mobile computing devices 14A, 14B are in the vehicle 26, but which in combination permit a proximity inference having sufficient accuracy for practical use.

Examples of potential proximity factors which may be used to make the location inference are listed below.

The mobile computing devices 14A, 14B may detect the proximity or presence of each other through means such as observing their mutual wireless transmissions. If a wireless transmission is observed by the mobile computing device 14B, a reasonable inference may be made to the mobile computing device 14A is within a given maximum distance from the mobile computing device 14B based on signal characteristics, signal strength, knowledge of the signal propagation, of the type of wireless signal and/or transmitter (e.g. based on the frequency and/or transmission protocol). This true even if the mobile computing devices 14A, 14B are not in active two-way communication with each other.

One example of a proximity factor is observation of position and/or velocity commonalities between or among the mobile computing devices 14A, 14B over an interval of time, the length of which may be a predetermined value. For example, if the mobile computing devices 14A, 14B report matching or closely similar (e.g. within measurement error) headings, matching or closely similar speeds, and/or matching or closely similar velocities, in each case over an interval of time, an inference may be made the mobile computing devices 14A, 14B are in close proximity (i.e. in the same vehicle). A longer interval of time for commonality indicates a higher statistical confidence in the inference.

Another example of a proximity factor is reception of wireless signals. For example, if mobile computing devices 14A, 14B report that they are close enough to observe the presence of their mutual wireless signals, or that of a third-party or sequence of third parties, over a certain time interval, the length of which may be a predetermined value, an inference may be made that they are in close proximity (i.e. in the same vehicle). For example, the time interval might be longer than would be expected in a single brief encounter, such as when two vehicles pass through the intersection of roads which cross each other. An extended interval of close proximity, such as one or more minutes, is more likely to indicate the mobile computing devices may be in the same vehicle.

Another example of a proximity factor is data such as accelerometer or inclinometer output from the mobile computing devices 14A, 14B (e.g. acceleration, velocity, distance, and/or orientation). For example, traces of measured data of acceleration versus time, or velocity versus time for the mobile computing devices 14A, 14B that are closely matching may permit an inference that they are in close proximity (i.e. in the same vehicle).

An example of the operation of the system 10 is described as follows. Initially, the client app 16 is installed on the mobile computing devices 14A, 14B. The users 12A, 12B may register a user account or otherwise establish connectivity with the backend server 24.

The client app 16 may be used by having the client app 16 active (e.g., running in the foreground or background) while the mobile computing devices 14A, 14B are within the passenger compartment 28 of the vehicle 26.

The system 10 receives and/or collects proximity factors as described above.

It is noted that the proximity factors need not be analyzed in real time. Various operational scenarios are possible. For example:

1. Each mobile computing device 14A, 14B may have a real time data connection to the backend application 22. In such situations, proximity factors may be transmitted over the data connection contemporaneously as they are collected.

2. Each mobile computing device 14A, 14B may have a delayed data connection. In such situations, proximity factors may be collected and stored (i.e. written to a file or memory) by the individual mobile computing devices and 14A, 14B. The proximity factors would then be transmitted over a data connection when it becomes available to either device, which may in turn, relay proximity factors that include reference to the other device, effectively completing the transmission.

3. One mobile computing device 14A may have a real time data connection to the backend application 22, and the other mobile computing device 14B may have a delayed data connection. In such situations, mobile computing device 14A may transmit its proximity factors over the data connection contemporaneously as they are being collected, while the mobile computing device 14B would collect and store proximity factors. Mobile computing device 14B would transmit its proximity factors over data connection when it becomes available. The proximity inference would be made once the system 10 deems itself to have sufficient data for a given purpose of the method.

The system 10 executes the rules and/or algorithms to make a proximity inference based on the proximity factors described above. The proximity inference is then available for use by the client app 16 and/or the backend application 22.

For example, the system 10 would make decisions relating to services (e.g. road tolls, parking fees, etc.) based on the devices being in or associated with the same vehicle. For example, the system 10 could apportion charges for a service equally amongst each of the users 12A, 12B. Alternatively, it could assign charges for service to one of the users based on a predetermined priority. In any event, the system 10 could apply business logic, which incorporates the knowledge of multiple devices being associated with the same vehicle, for an independent practical application.

In addition to, or as an alternative to the proximity inference method described above, the system 10 may be used to make an inference that two or more mobile computing devices are 14 associated with the same vehicle 26, even though they may not simultaneously be in the same vehicle 26. By “associated” it is meant that the devices have some functional or contractual relationship to the same vehicle 26. For purposes of illustration, FIG. 1 shows an example of a user 12C located outside the vehicle 26 having a mobile computing device 14C running the client app 16 and connected to wide area network 20 by communications channel 18.

As with the mobile computing devices 14A, 14B described above, the users 12C may register a user account or otherwise establish connectivity with the backend server 24. The user account may include a list or other data establishing that the user 12C is associated with the vehicle 26 in some respect. For example, the user 12C may be an owner, manager, lessor, or primary user of the vehicle 26. This information may then be used by the system 10 to make decisions and/or take actions based on a determination that at least one of the mobile computing devices 14 is in the vehicle 26 and that more than one mobile computing device 14 is associated with the vehicle 26.

The foregoing has described a system and method for inferring the presence and/or association of multiple mobile computing devices with a vehicle. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of detecting multiple devices associated with a vehicle, comprising:
positioning two or more mobile computing devices in a common vehicle;
collecting at least one proximity factor about each of the mobile computing devices, wherein the at least one proximity factor evidences close physical proximity of the two or more mobile computing devices,
using an electronic processor, executing at least one software rule to make a proximity inference of the mobile computing devices, based on the at least one proximity factor; and
storing the result of the proximity inference for further use.

2. The method of claim 1 wherein the proximity inference is made at least in part in response to the mobile computing devices reporting that they are close enough to receive each other's wireless signals, over a predetermined time interval.

3. The method of claim 1 wherein the proximity inference is made at least in part in response to the mobile computing devices reporting that they are close enough to receive a common third party wireless signal, over a predetermined time interval.

4. The method of claim 1 wherein the proximity inference of the primary mobile computing device is made at least in part in response to the mobile computing devices having a common heading, speed, or velocity, over a predetermined time interval.

5. The method of claim 1 wherein the proximity inference of the primary mobile computing device is made at least in part in response to the mobile computing devices having common traces of measured data of acceleration versus time, or velocity versus time, or orientation versus time, over a predetermined time interval.

6. The method of claim 1 wherein the at least one proximity factor is relayed to a backend application over a data communications connection.

7. The method of claim 6 wherein:
each of the mobile computing devices has a real time data connection to the backend application; and
proximity factors are transmitted over the data connection contemporaneously as they are collected.

8. The method of claim 6 wherein:
each of the mobile computing devices has a data connection to the backend application which is delayed;
the at least one proximity factor is collected and stored by one or more of the mobile computing devices; and
the at least one proximity factor is transmitted over the data connection to the backend application when the data connection becomes available to any of the mobile computing devices.

9. The method of claim 8 wherein one of the mobile computing devices relays the at least one proximity factor from another one of the mobile computing devices to the backend application.

10. The method of claim 6 wherein:
at least one of the mobile computing devices has a real time data connection to the backend application;
proximity factors collected by the at least one mobile computing device having a real time data connection are transmitted over the data connection contemporaneously as they are collected;
at least one of the mobile computing devices has a data connection to the backend application which is delayed; and
proximity factors collected by the at least one mobile computing device having a delayed data connection are stored and transmitted over the data connection to the backend application when the data connection becomes available.
